(19) United States
(12) Patent Application Publication
(10) Pub. No.: US 2026/0047561 A1
(43) Pub. Date: Feb. 19, 2026

(54) METHOD AND IDENTIFICATION DEVICE FOR IDENTIFICATION OF A SHELL OF A CRUSTACEAN

(71) Applicant: LAGOSTA SA, St-Prex (CH)

(72) Inventors: Christophe Maier, St-Prex (CH); Sebastien Ferraz, La Colle sur Loup (FR)

(21) Appl. No.: 19/102,283

(22) PCT Filed: Aug. 7, 2023
(86) PCT No.: PCT/EP2023/071799

§ 371 Date: Feb. 7, 2025

(30) Foreign Application Priority Data
Aug. 9, 2022 (CH) CH000940/2022

(51) Int. Cl. A01K 61/90; G06V 10/74; G06V 40/00

(52) U.S. Cl. CPC A01K 61/90; G06V 10/761; G06V 40/00

(57) ABSTRACT

A method and identification device (115) for identification of a shell (110) of a crustacean (100), wherein the method comprises receiving, in a processor (130), a captured digital image (200) of at least a part of a shell (110) of the crustacean (100), identifying, in the processor (130), a shell pattern (154) on the shell (110) using the digital image (200), wherein the shell pattern (154) is unique for each individual crustacean and identifying, in the processor (130), the shell (110) of the crustacean (100) by positively matching the identified shell pattern (154) to one of a plurality of stored shell patterns (152), wherein each of the stored shell patterns (152) is associated to one previously identified crustacean (102)

### FIELD OF THE DISCLOSURE

The present disclosure relates to a method for identification of a shell of a crustacean and an identification device for identification of a shell of a crustacean. Specifically, the present disclosure relates to a method for identification of a shell of a crustacean using a processor, further to a computer program product configured to control a processor for executing the method for identification of a shell of a crustacean and further to an identification device for identification of a shell of a crustacean.

### BACKGROUND OF THE DISCLOSURE

A crustacean is an animal with a hard shell and several pairs of legs, which usually lives in water. Animals like crabs, lobsters, spiny lobsters or shrimps are considered crustaceans. The different crustaceans are used as seafood in different varieties and many of the different kinds of crustaceans are considered a delicacy on different parts of the world. Widely known as delicacy are in particular crabs, lobsters, spiny lobsters and shrimps. This delicacy status of these animals led to a high demand on the world markets for these animals. Many of these animals are therefore overfished. For many of the different species of crustaceans it is still not possible to hold them in aquaculture. Which further increases the pressure on the wildlife population.

In addition, the shell of the crustacean can be used as a raw material for the production of chitin and chitosan. These materials are used in different areas of applications like in biotechnology industry. Conventionally, the shell of shrimps is used for the production of chitin. The outer shell of the dead shrimps is removed from the main body and the outer shell is then further processed. Conventionally, flesh or other parts of the main body of the shrimps remain on the shell, which leads to a contamination and low quality of the shells. Overall, the quality of the shells is conventionally very poor and unstable, in particular, because flesh particles or other particles of the main body remain on the shell. In addition, the shells exhibit seasonality in their overall composition as being removed from wild animals from fisheries. The poor quality of the shells results in a poor quality of the resulting chitin.

Further, the quality of the resulting chitin is also depending on further factors, which are influenced by the animal itself. The shell of the crustaceans is their exoskeleton. For growing, each animal having an exoskeleton must molt. During the molting process, the animal literally crawls out of the old shell. The molting process begins with a hormonal change that softens the exoskeleton of the crustacean. At the point when molting begins, the animal begins to move out of a crack that forms between their cephalothorax and abdomen. The crustacean must pull each antenna, leg and even their eyeballs out of the outer exoskeleton. After crawling out of the outer shell, hormones are released, and the new shell begins to harden.

In addition, conventionally, the waste of different crustacean farms or fisheries, which comprises the shells of different species of crustaceans, is currently used as raw material for the chitin production. The chitin producer receives different batches comprising shells from different crustaceans. Without the knowledge of the species from which the shells results and the knowledge of the composition of the shell itself, it is highly unlikely that the resulting products have a desired high quality.

Further, the quality of the chitin depends on the age of the animal, the annual season during which the shell is processed and further properties. Current technologies do not take into account the above-mentioned properties of the raw material, in particular because it is currently not possible to know the above-mentioned properties of the raw material, which results in poor and unstable quality with varying properties of the resulting chitin and chitosan.

### SUMMARY OF THE DISCLOSURE

It is an object of the present disclosure to provide a method and an identification device for identification of a shell of a crustacean. In particular, it is an object of the present disclosure to provide a method and an identification device, which method and device do not have at least some of the disadvantages of the prior art.

According to the present disclosure, these objects are addressed by the features of the independent claims. In addition, further advantageous embodiments follow from the dependent claims and the description.

According to the present disclosure, the above-mentioned objects are particularly achieved by a method for identification of a shell of a crustacean. The method comprises:
receiving, in a processor, a captured digital image of at least a part of a shell of the crustacean, preferably of an abdomen of the crustacean;
identifying, in the processor, a shell pattern on the shell using the digital image, wherein the shell pattern is unique for each individual crustacean;
identifying, in the processor, the shell of the crustacean by positively matching the identified shell pattern to one of a plurality of stored shell patterns, wherein each of the stored shell patterns is associated to one previously identified crustacean.

In an embodiment, identifying of the shell pattern comprises determining, in the processor, at least one main visual mark on the shell, using the digital image; and determining, in the processor, a contour line of the main visual mark(s) on the shell.

In an embodiment, the at least one main visual mark (also primary visual mark) is on a top face of the shell of the crustacean. In an embodiment, the at least one main visual mark is on the cephalothorax and/or the abdomen and/or the tail. In an embodiment, the at least one main visual mark is yellow, white or a shade of white, such as beige, cream, ivory, vanilla or eggshell.

In an embodiment, identifying of the shell pattern further comprises determining in the processor, at least one secondary visual mark on the shell, using the digital image; and determining, in the processor, a contour line of the secondary visual mark(s) on the shell.

In an embodiment, the captured digital image shows at least one segment of an abdomen of the crustacean, preferably at least two segments of the abdomen of the crustacean, more preferably four segments of the abdomen of the crustacean, wherein each segment comprises the main visual mark and/or the secondary visual mark.

In an embodiment, identifying the shell of the crustacean comprises accessing, by the processor, a database comprising the plurality of the stored shell patterns, wherein the stored shell patterns comprise contour line(s) of the main visual mark(s) and/or contour line(s) of the secondary visual mark(s).

In an embodiment, identifying the shell of the crustacean comprises comparing, in the processor, the determined contour line of the main visual mark(s) and/or the determined contour line of the secondary visual mark(s) with the contour lines of the main visual mark(s) and/or the contour lines of the secondary visual marks of the stored shell patterns.

In an embodiment, identifying the shell of the crustacean comprises: calculating, in the processor, a matching probability for a combination of the identified shell pattern and the plurality of stored shell patterns; and positively matching, by the processor, the shell pattern of the crustacean to the stored shell pattern having the highest matching probability, if the matching probability reaches or surpasses a predefined matching threshold; or negatively matching, by the processor, the shell pattern of the crustacean, if the calculated matching probability does not reach a predefined matching threshold.

In an embodiment, the shell of the crustacean is the shell of a living crustacean or a molt of a crustacean.

In an embodiment, the method further comprises adding, by the processor, a new entry into the database of a new shell pattern, if the identified shell pattern is negatively matched.

In an embodiment, the method further comprises updating, by the processor, a stored shell pattern in the database with the identified shell pattern, if the identified shell pattern is positively matched.

In an embodiment, the crustacean is a reptantia crustacean, preferably an achelate crustacean, more preferably a spiny lobster. In an embodiment, the crustacean is selected from the following: Palinuridae elephas, Palinuridae japonicas, Palinuridae homarus, Palinuridae strimpsoni, Palinuridae guttatus, Palinuridae versicolor, Palinuridae omatus, Palinuridae Jasus, Palinuridae Justitia, Palinuridae Linuparus, Palinuridae Nupalirus.

In a further aspect of the present disclosure, a computer program product is specified comprising a non-transitory computer readable medium having stored thereon computer program code configured for controlling at least one processor of a computer such that the computer program code causes the computer to execute one of the previously and hereinafter mentioned methods.

In a further aspect of the present disclosure, an identification device for identification of a shell of a crustacean is specified. The identification device comprises a processor configured to:
receive a captured digital image of at least a part of a shell of the crustacean;
identify a shell pattern on the shell using the digital image, wherein the shell pattern is unique for each individual crustacean; and
identify the shell of the crustacean by positively matching the identified shell pattern to one of a plurality of stored shell patterns, wherein each of the stored shell patterns is associated to one previously identified crustacean.

In an embodiment, the identification device further comprises a camera configured to capture the digital image of at least the part of the shell of the crustacean.

In an embodiment, the identification device further comprises a database configured to provide, for the processor, the plurality of the stored shell patterns.

In an embodiment, the identification device further comprises a framework configured to define a constant distance between the camera and the shell of the crustacean during capturing of the digital image. In addition, the framework advantageously is further configured to define a constant light during capturing of the digital image.

In an embodiment, the identification device further comprises a user interface configured to display to a user of the identification device whether the unique shell pattern matches one of the plurality of stored shell patterns and further configured to receive commands from the user and configured to transmit the commands to the processor.

In an embodiment, the processor of the identification device is configured to execute one of the previously mentioned methods.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The present disclosure will be explained in more detail, by way of example, with reference to the drawings in which:

FIG. 1: shows a block diagram illustrating schematically an identification device for identification of a shell of a crustacean,

FIG. 2: shows a plurality of different digital images comprising a shell pattern of a shell of a crustacean,

FIG. 3: shows a captured digital image of a shell pattern of a crustacean and a digital image of a stored shell pattern of a crustacean,

FIG. 4: shows a flow diagram illustrating schematically a plurality of steps performed by a processor, a camera, a database and an user interface for identifying a shell of a crustacean,

FIG. 5: shows a first exemplary embodiment of a step for identifying a shell pattern of FIG. 4,

FIG. 6: shows a second exemplary embodiment of the step for identifying the shell pattern of FIG. 4,

FIG. 7: shows an exemplary embodiment of a step identifying a shell to a crustacean of FIG. 4.

### DESCRIPTION OF THE EMBODIMENTS

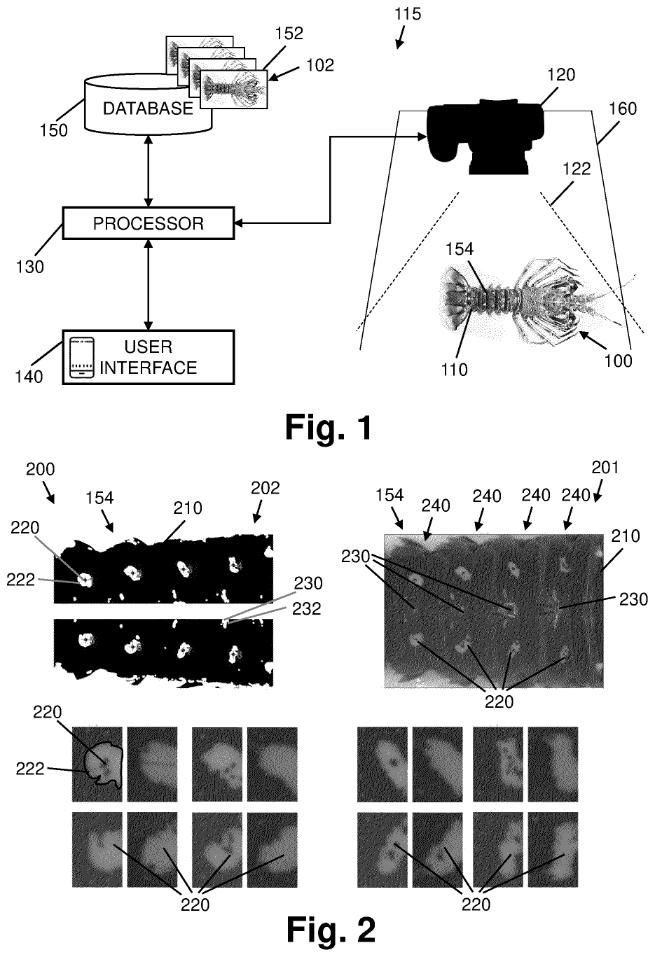

FIG. 1 shows schematically an identification device 115 which is configured to identify a shell 110 of a crustacean 100. The identification device 115 comprises a processor 130 which is configured to control the different parts of the identification device 115 and which is configured to execute a computer program code for controlling the identification device 115 and for identification of the shell 110 of a crustacean 100. The identification device 115 further comprises a camera 120, configured to capture at least one digital image 200 (as shown in FIG. 2) of at least a part of the crustacean 100. The camera 120 and the processor 130 are interconnected such that the captured digital image 200 can be transmitted from the camera 120 to the processor 130. In an embodiment, the connection between the camera 120 and the processor 130 is a wire connection. In another embodiment, the connection is a wireless connection. In yet another embodiment, the processor 130 and the camera 120 are arranged within one device. The identification device 115 further comprises a framework 160 which is connected to the camera 120 and which is configured to define a constant distance between the camera 120, in particular between a camera lens, and the object to be photographed. The framework 160 helps to create digital images, which are advantageous, simple to compare. FIG. 1 further shows schematically a database 150, which is configured to store a plurality of shell patterns 152 of previously identified crustaceans 102. In other words, the database 150 stores data, for example image data or contour data, comprising shell patterns 152, which are associated to individual crustaceans 102, which were previously added to the database 150. The database 150 is, in an embodiment, integrated in the processor 130 or in a common device, which also comprises the processor 130. In this case, the database 150 is interconnected to the processor 130 by wire. In another embodiment, the database 150 is a remote server, for example a cloud server. In this case, the database 150 is, for example, connected to the processor 130 or to the identification device 115 via a communication network. FIG. 1 further shows a user interface 140 which is connected to the processor 130 and which is configured to display data to a user of the identification device 115. The user interface 140 is further configured to receive and transmit commands from the user to the processor 130. The processor 130 is configured to execute the received commands.

The processor 130 of the identification device may comprise a central processing unit (CPU) for executing the computer program code stored in a non-transitory computer readable medium. The processor 130 of the identification device may also include more specific processing units, such as application-specific integrated circuits (ASICs), reprogrammable processing units such as field programmable gate arrays (FPGAs), or processing units specifically configured for this application.

The communication network which may be used to transfer data between the processor 130 and the database 150 of the processor 130 and the camera 120 and/or the processor 130 and the user interface 140 uses, for example, a mobile data network, such as Global System for mobile Communication (GSM), Code Division Multiple Access (CDMA), or Long Term Evolution (LTE) networks, and/or a close range wireless communication interface using a Wi-Fi network (WLAN), Bluetooth, and/or other wireless network types and standards.

In an embodiment, the identification device 115 comprises the processor 130, the database 150, the camera 120, the framework 160 and/or the user interface 140 in one housing. In this case, the identification device 115 may be a handheld device or a smart phone. In another embodiment, the identification device 115 comprises a laptop or a computer, which comprises the processor 130 and the database 150. The camera 130 may be connected to the laptop or the computer.

FIG. 1 further shows the crustacean 100, in particular a spiny lobster arranged in a visual field 122 of the camera 120. The shell 110 is the exoskeleton of the crustacean 100. The shell 110 comprises a shell pattern 154. A digital image 200 captured with the camera 120 shows at least partially the shell pattern 154 on the shell 110 of the crustacean 100.

FIG. 2 shows a plurality of different digital images 200 comprising a shell pattern 154 of the shell 110 of the crustacean 100. In particular, FIG. 2 can be divided into four parts. The upper right part, the upper left part, the lower right part and the lower left part. The upper right part shows a first digital image 201 of the shell 110 of the crustacean 100 as presented in FIG. 1. The digital image 201 is in this embodiment a greyscale digital image. The digital image 201 shows partially the shell 110 of the crustacean 100, in particular, the digital image 201 shows a backside of an abdomen 210 of the shell 110. The abdomen 210 comprises four segments 240 each comprising two main visual marks 220 and at least one secondary visual mark 230. The secondary visual marks 230 are mainly arranged on or near a longitudinal axis of the crustacean 100 and the two main visual marks 220 are arranged mirrored with respect to the longitudinal axis, such that one of the main visual marks 220 is arranged on one of the segments 240 on one side with respect to the longitudinal axis and that the other of the main visual marks 220 is arranged on the same segment 240 on the other side with respect to the longitudinal axis. Overall, the main visual marks 220 and the secondary visual marks 230 define the shell pattern 154. The shell pattern 154 may also be defined by a selection of the available visual marks 220 and the available secondary visual marks 230 and/or other visual marks on the shell 110.

The upper left part of FIG. 2 shows a second digital image 202, which differs from the first digital image 201 in its contrast. The digital image 202 shows the same shell 110 as the digital image 201. The grayscale digital image 201 has been processed, by the processor 130, into the black and white digital image 202. This helps to make the main visual marks 220 and the secondary visual marks 230 more distinguishable from rest of the shell 110. The digital image 202 further shows schematically a contour line 222 of the main visual marks 220 and a contour line 232 of the secondary visual marks 230. The contour lines 222 and 232 are the outer boundaries of the main visual marks 220 and of the secondary visual marks 230. The main visual marks 220 and the secondary visual marks 230 are defined by a different pigmentation compared to the rest of the shell 110. In other words, the main visual marks 220 and the secondary visual marks 230 appear brighter on the digital images 200 compared to the rest of the shell 110. The boundary line between the bright side (visual marks) and the rest of the shell 110 is the contour line 222, 232.

The lower left part of FIG. 2 and the lower right part of FIG. 2 show a detailed view of the eight main visual marks 220 of the four segments 240 of the abdomen 210 of two different crustaceans 100. The lower left part of FIG. 2 also shows an outer contour line 222 of a main visual mark 220. The lower left parts visualize the differences in the main visual marks 220 of different crustaceans and show that these main visual marks 220 alone or in combination with the secondary visual marks 230 can be used to identify clearly an individual crustacean 100. The shell pattern 154 may be compared to a fingerprint of a human, which clearly identifies an individual.

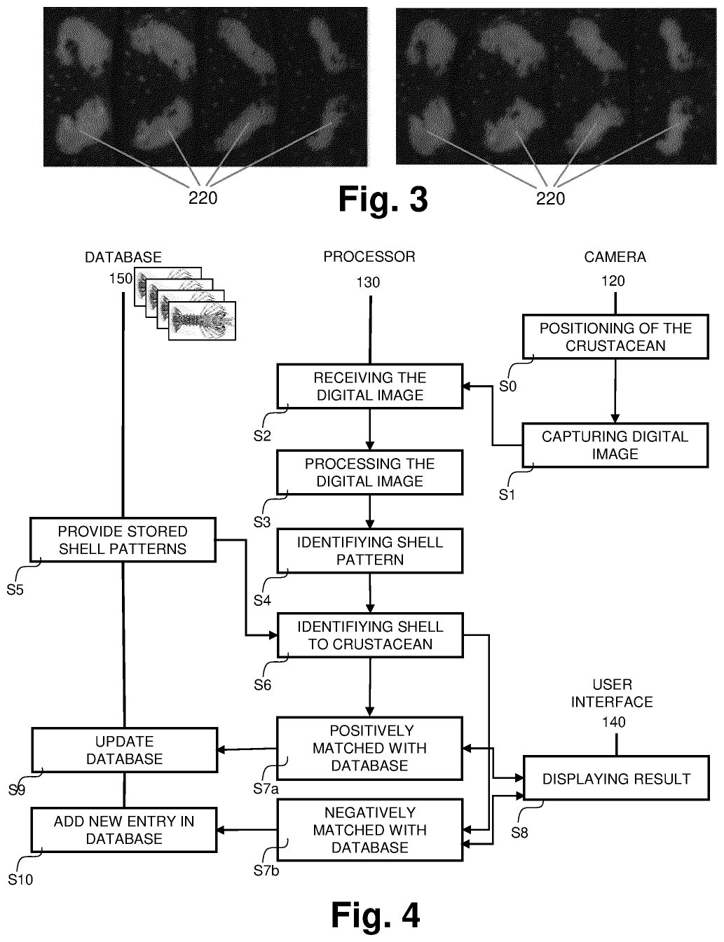

FIG. 3 shows a plurality of different main visual marks 220. The left part of FIG. 3 shows eight main visual marks 220 of a specific crustacean 100 at a specific point in time and the right part of FIG. 3 shows eight main visual marks 220 of the same crustacean 100 at a different point in time. Between these two points in time, the crustacean 100 has molted. In other words, the left part of FIG. 3 shows for example, the current main visual marks 220 on the abdomen 210 of the crustacean 100 and the right part of FIG. 3 shows the main visual marks 220 of the molt (old shell) of the crustacean 100. It can be seen in the FIG. 3 that the outer contour lines 222 of the main visual marks have hardly change. Only minor changes in size or shape are visible. In other words, the shell pattern 154 of the molt can clearly be linked to the shell patterns 154 of the same crustacean 100 or to a shell pattern 154 of a former molt. Each molt can therefore be assigned or linked to a specific crustacean 100 throughout the entire life of the crustacean 100 and/or the crustacean 100 itself can throughout its entire lifetime be identified by the shell pattern 154 on the abdomen 210 of the crustacean 100.

FIG. 4 shows a flow diagram illustrating schematically a sequence of steps performed for identifying a shell 110 of a crustacean 100. In the following paragraphs, described with reference to FIG. 4 is a possible sequence of steps, performed using the processor 130, the camera 120, the database 150 and the user interface 140 of the identification device 115, for identifying a shell 110 of a crustacean 100.

In step S0, the camera 120 or the shell 110 of the crustacean 100, is positioned such that a digital image of the shell 110 of the crustacean 100 can be captured. In an embodiment, the camera 120 of the identification device 115 is arranged within the specific framework 160 at a predefined position. In this scenario, the crustacean 100 or the shell 110 of the crustacean is positioned in the visual field 122 of the camera 120. In another embodiment, for example in the water, a diver trying to observe a wildlife population of spiny lobsters, carries the identification device 115 and places the camera 120 such that the desired digital image 200 of the shell 110 of the crustacean 100 can be taken.

In step S1, the camera 120 captures the digital image 200 of at least a part of the shell 110 of the crustacean 100. It is preferred that the camera 120 captures the digital image 200 with at least one segment 240 of the abdomen 210 of the shell 110. The digital image 200 is afterwards transmitted from the camera 120 to the processor 130.

In step S2, the processor 130 receives the digital image 200 for further processing it. Transmitting the digital image 200 from the camera 120 to the processor 130 may be performed by wire or wireless.

In step S3, the processor 130 processes the digital image 200 by changing its properties. The processor 130 amends, for example, the contrast of the digital image 200 and/or transforms the digital image 200 from a colored image to a greyscale image and/or increases a contrast of the digital image 200. Such amendments help to increase the visibility of the unique shell pattern 154 on the shell 110. Additionally, such amendments may make marks, contours and/or features visible that are otherwise not visible, possibly due to absorption outside the visible range.

In step S4, the processor 130 identifies the shell pattern 154 of the received digital image 200. The identification of the shell pattern 154, as for example visible in the FIGS. 2 and 3, may be performed using different kind of image recognition algorithms and/or machine learning algorithms. In an embodiment, the processor 130 identifies the shell pattern 154 by determining the outer contour line 222 of at least one, preferably of all available, main visual marks 220 of the digital image 200. The contour line 222 is determined, for example, by identifying boarders of bright spots/dark areas in the digital image 200. Other possible solutions to identify the contour line 222 are also conceivable. The identified contour line 222 or the identified contour lines 222 of the main visual marks 220 and/or the contour line(s) 232 of the secondary visual marks 230 are combined and identified as shell pattern 154 of the shell 110.

In step S5, the database 150 provides the plurality of stored shell patterns 152 for the processor 130. In other words, the processor 130 may access the database 150 comprising the stored shell patterns 152.

In step S6, the processor 130 identifies the shell 110 of the crustacean 100, by positively matching the identified shell pattern 154 to one of the plurality of the stored shell patterns 152. The identified shell pattern of step S4 is in step S6, for example compared to all of the available stored shell patterns 152 until the identified shell pattern 154 matches one of the plurality of the stored shell patterns 152.

The steps 7a and 7b represent the two outcome possibilities of step S6. The first possibility, represented by step S7a, is that the identified shell pattern 154 is positively matched to a stored shell pattern 152. The second possibility, represented by step S7b, is that the identified shell pattern 152 is negatively matched (not matched to any one of the available stored shell patterns 154).

In an embodiment, the processor 130 determines the matching probability of each combination. An identified shell pattern 154 is positively matched to the stored shell pattern 152 with the highest matching probability. In a further embodiment, the identified shell pattern 154 is only positively matched when the highest matching probability of a combination reaches or surpasses a predefined matching probability threshold, for example, 75%, more preferably 85%, even more preferably 95%. The identified shell pattern 154 is negatively matched when the highest matching probability does not reach the predefined matching threshold.

In step S8, the user interface 140 of the identification device 115, displays the result of the step S6. The user interface 140 may display that the identified shell pattern 154 is positively matched or may display that the shell pattern 154 is negatively matched. The user interface 140 may receive the data to be displayed from the processor 130.

In step S9, the database 150 is updated with the last matching shell pattern 154. The update is, for example, automatically initiated or is initiated by the user via the user interface 140. Updating comprises that the stored shell pattern 152 is updated by the positively matching identified shell pattern 154. In this case, this particular shell pattern may comprise two or more data-points, which helps to increase the accuracy of the identification of future shells 110.

In step S10, a new database entry in the database 150 is added or created. The adding of a new database entry is initiated, for example, automatically in case the identified shell pattern 154 is negatively matched (see step S7b) or the adding of a new database entry is, for example initiated by the user via the user interface 140. In an embodiment, the negatively matched identified shell pattern 154 is added to the database 150 by creating a new crustacean entry with, for example, a unique identification number (ID) linked to the crustacean and the negatively matched identified shell pattern 154. Every new crustacean 100, shell 110 of the new crustacean 100, must be added to the database 150 in order to identify future molts of this crustacean 100 or a future digital image 200 of the shell 110 of this crustacean 100.

The method according to the present disclosure uses the shell pattern 154 on the shell 110 of crustaceans to clearly identify molts/exuviae or shells 110 of a particular crustacean 100 to already identified stored shell patterns 152. The method provides the possibility to identify the molts throughout the entire lifespan of a crustacean 100. Therefore, it is possible to group the molts of one particular crustacean 100 or to group molts of a group of crustaceans 100, which can afterwards be used for an advantageous chitin and chitosan production.

Further, it is possible to monitor a wildlife population of crustaceans 100 and to identify the different individuals and to pursue the development of the individual crustaceans 100. Further, it is possible to monitor cultured individuals for the seafood market.

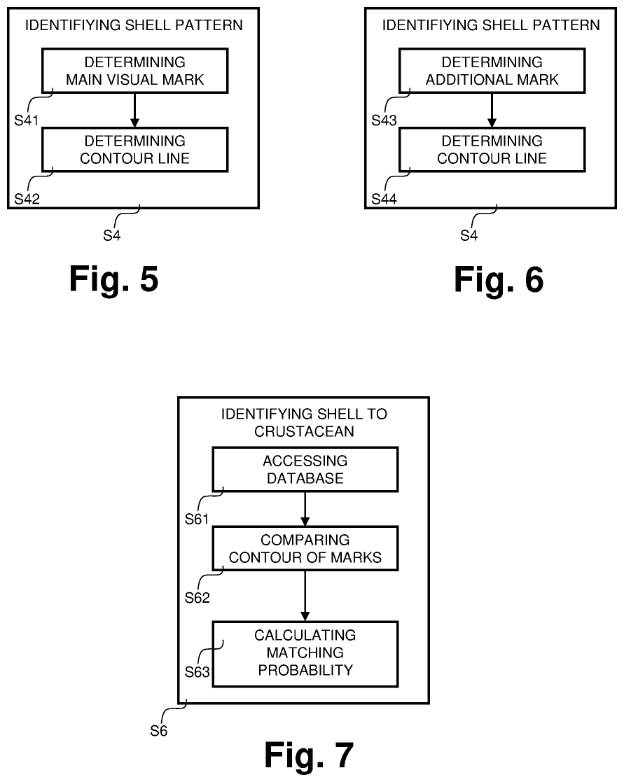

FIG. 5 shows a first exemplary embodiment of the step S4 for identifying the shell pattern 154 as disclosed in FIG. 4. In the following paragraphs, described with reference to FIG. 5 is a possible first sequence of steps, performed by the processor 130 to identify the shell pattern 154 of the received digital image 200.

In step S41, the processor 130 determines at least one main visual mark 220. In an embodiment, all of the available, for example, eight main visual marks 220 are determined. The number of the available visual marks 220 depends on the digital image 200. Having more main visual marks 220 increases the accuracy. The main visual marks 220 are for example determined/identified automatically, by the processor 130, using a specific algorithm, which determines bright spots on the shell 110. In another embodiment, the main visual marks 220 are determined with the aid of the user.

In step S42, the processor 130 determines the contour line 222 of the main visual mark 220. The contour line 222 is the optical border of the main visual mark 220 and the rest of the shell 110. The contour line 222 of the main visual mark 220 or the contour lines 222 of the plurality of the main visual marks 220 are for example automatically determined by the processor 130 using an algorithm, which draws a line between the bright areas and the darker areas of the digital image 200. The drawn line is the contour line 222 of the at least one main visual mark 220. The contour lines 222 require less storage space compared to the digital images 200. The contour line(s) 222 are according to this embodiment the identified shell pattern 154. The contour line(s) 222 are afterwards, in step S6 identified to the stored shell patterns 152.

FIG. 6 shows a second exemplary embodiment of the step S4 for identifying the shell pattern 154 as disclosed in FIG. 4. In the following paragraphs, described with reference to FIG. 6 is a possible first sequence of steps, performed by the processor 130 to identify the shell pattern 154 of the received digital image 200.

In step S43, the processor 130 determines a secondary visual mark 230. Also here, the number of available secondary visual marks 230 depend on the digital image 200. Having more secondary visual marks 230 increases the accuracy. The method for determining the secondary visual marks 230 on the shell 110 is, in an embodiment, the same as for the main visual marks 220.

In step S44, the processor 130 determines the contour line 232 of the secondary visual marks 230. The contour line 232 is the optical boarder of the secondary visual mark 230 and the rest of the shell 110. The method for determining the contour line 232 of the secondary visual marks 230 on the shell 110 is, in an embodiment, the same as for the contour line 222 of the main visual marks 220.

In an embodiment, the step S4 comprises the steps S41, S42, S43 and S44. In other words, the identification of the shell pattern 154 is performed, by the processor 130, using the main visual marks 220 in combination with the secondary visual marks 230, which increases the accuracy.

FIG. 7 shows an exemplary embodiment of the step S6 “identifying an identified shell pattern 154 to a crustacean” of FIG. 4. In the following paragraphs, described with reference to FIG. 7 is a possible sequence of steps, performed by the processor 130 to identify the shell pattern 154 to a stored shell pattern 152.

In step S61, the processor 130 accesses the database 150 comprising the stored shell patterns 152. Accessing may comprise that the processor 130 receives access to the database 150.

In step S62, the processor 130 compares the contour lines 222 of the identified main visual marks 220 and/or the contour lines 232 of the identified secondary visual marks 230 with in the database 150 stored contour lines of stored shell patterns 152. In an embodiment, the processor 130 compares all the available stored shell patterns 152 with the identified shell pattern 154. In another embodiment, the processor 130 compares only specific, preselected stored shell patterns 152 with the identified shell pattern 154, which may reduce time. Other comparing algorithms are also conceivable.

In step S63, the processor 130 calculates or determines a matching probability for each combination of identified shell pattern 154 and stored shell pattern 152. The matching probability determines, for example, how similar the contour lines 222, 232 of the identified shell pattern 154 are compared to the contour lines 222, 232 of the stored shell patterns 152. In a possible next step the highest matching probability is compared, by the processor 130, to a matching probability threshold, which is predefined and for example stored in the processor 130. Only if the highest matching probability reaches or surpasses the matching probability threshold, the identified shell pattern 154 is positively matched (see step S7a of FIG. 4). In case the highest matching probability does not reach the predefined matching threshold, the identified shell pattern 152 is negatively matched (see step S7b of FIG. 4).

In a further embodiment, the processor 130 shows, using the user interface 140, to the user results of the identification step S6. For example, the processor 130 determines that different combination have a similar matching probability, wherein all reach or surpass the matching probability threshold. In this case, all of these combinations may be displayed to the user and the user makes the positive/negative matching selection based on, for example, his/her experience.

It should be noted that, in the description, the sequence of the steps has been presented in a specific order, one skilled in the art will understand, however, that the order of at least some of the steps could be altered, without deviating from the scope of the disclosure.

### LIST OF DESIGNATIONS

100 crustacean
110 shell
115 identification device
120 camera
122 visual field
130 processor
140 user interface
150 database
152 stored shell patterns
154 unique shell pattern
160 framework
200 digital image
201 first digital image
202 second digital image
210 abdomen
220 main visual mark
222 contour line of the main visual mark
230 secondary visual mark
232 contour line of the secondary visual mark
240 segment

1. A method for identification of a shell (110) of a crustacean (100), the method comprising:
receiving (S2), in a processor (130), a captured digital image (200) of at least a part of a shell (110) of the crustacean (100);
identifying (S4), in the processor (130), a shell pattern (154) on the shell (110) using the digital image (200), wherein the shell pattern (154) is unique for each individual crustacean;
identifying (S6), in the processor (130), the shell (110) of the crustacean (100) by positively matching the identified shell pattern (154) to one of a plurality of stored shell patterns (152), wherein each of the stored shell patterns (152) is associated to one previously identified crustacean (102).

2. The method according to claim 1, wherein identifying (S4) of the shell pattern (154) comprises:
determining (S41), in the processor (130), at least one main visual mark (220) on the shell (110), using the digital image;
determining (S42), in the processor (130), a contour line (222) of the main visual mark(s) (220) on the shell (110).

3. The method according to claim 1, wherein identifying (S4) of the shell pattern (154) comprises:
determining (S43), in the processor (130), at least one secondary visual mark (230) on the shell (110), using the digital image;
determining (S44), in the processor (130), a contour line (232) of the secondary visual mark(s) (230) on the shell.

4. The method according to claim 2, wherein the captured digital image shows at least one segment (240) of an abdomen (210) of the crustacean (100), wherein each segment (240) comprises at least one of: the main visual mark (220) or the secondary visual mark (230).

5. The method according to claim 1, wherein identifying (S6) the shell (110) of the crustacean (100) comprises:
accessing (S61), by the processor (130), a database (150) comprising the plurality of the stored shell patterns (152), wherein the stored shell patterns (152) comprise at least one of: contour line(s) (222) of the main visual mark(s) (220) or contour line(s) (232) of the secondary visual mark(s) (230).

6. The method according to claim 5, wherein identifying (S6) the shell (110) of the crustacean (100) comprises:
comparing (S62), in the processor (130), the determined (S42) contour line (222) of the main visual mark(s) (220) and/or the determined (S44) contour line (232) of the secondary visual mark(s) (230) with the contour lines (222) of the main visual mark(s) (220) and/or the contour lines (232) of the secondary visual marks (230) of the stored shell patterns (152).

7. The method according to claim 1, wherein identifying (S6) the shell (110) of the crustacean (100) comprises:
calculating (S63), in the processor (130), a matching probability for each combination of the identified shell pattern (154) and the plurality of stored shell patterns (152); and
positively matching (S7a), by the processor (130), the shell pattern (154) of the crustacean (100) to the stored shell pattern (152) having the highest matching probability, if the matching probability reaches or surpasses a predefined matching threshold; or
negatively matching (S7b), by the processor (130), the shell pattern (154) of the crustacean (100), if the calculated matching probability does not reach a predefined matching threshold.

8. The method according to claim 1, wherein the shell (110) of the crustacean (100) is the shell (110) of a living crustacean or a molt of a crustacean.

9. A computer program product comprising a non-transitory computer readable medium having stored thereon computer program code configured for controlling at least one processor (130) of a computer such that the computer program code causes the computer to execute a method according to claim 1.

10. An identification device (115) for identification of a shell (110) of a crustacean (100) comprising a processor (130) configured to:
receive (S2) a captured digital image (200) of at least a part of a shell (110) of the crustacean (100);
identify (S4) a shell pattern (154) on the shell (110) using the digital image (200), wherein the shell pattern (154) is unique for each individual crustacean; and
identify (S6) the shell (110) of the crustacean (100) by positively matching the identified shell pattern (154) to one of a plurality of stored shell patterns (152), wherein each of the stored shell patterns (152) is associated to one previously identified crustacean (102).

11. The identification device (115) according to claim 10, further comprising a camera (120) configured to:
capture (S1) the digital image (200) of at least the part of the shell (110) of the crustacean (100).

12. The identification device (115) according to claim 10, further comprising a database (150) configured to:
provide (S5), for the processor (130), the plurality of the stored shell patterns (152).

13. The identification device (115) according to claim 11, further comprising a framework (160) configured to:
define a constant distance between the camera (120) and the shell (110) of the crustacean (100) during capturing (S1) of the digital image (200).

14. The identification device (115) according to claim 10, further comprising a user interface (140) configured to:
display to a user of the identification device (115) whether the unique shell pattern (154) matches one of the plurality of stored shell patterns (152); and
receive commands from the user and transmit the commands to the processor (130).

15. The identification device (115) according to claim 10, wherein the processor (130) is configured to:
receive a captured digital image (200) of at least a part of a shell (110) of the crustacean (100);
identify a shell pattern (154) on the shell (110) using the digital image (200), wherein the shell pattern (154) is unique for each individual crustacean; and
identify the shell (110) of the crustacean (100) by positively matching the identified shell pattern (154) to one of a plurality of stored shell patterns (152), wherein each of the stored shell patterns (152) is associated to one previously identified crustacean (102).
